(19) United States
(12) Patent Application Publication
(10) Pub. No.: US 2016/0353145 A1
(43) Pub. Date: Dec. 1, 2016

(54) SYSTEM AND METHOD FOR INCENTIVIZING PERSONALIZED PACKAGES IN A DIGITAL MEDIUM

(71) Applicant: Magine Holding AB, Stockholm (SE)

(72) Inventors: Victor Ahlm, Arsta (SE); James Mole McConnell, Norrkoping (SE); Joel Bohman, Sundbyberg (SE); Michael Krzysztof Gniady, Solna (SE); Roger Bo Erik Nordquist, Stockholm (SE); Lars Gunnar Vilson, Hagersten (SE)

(21) Appl. No.: 14/727,064

(22) Filed: Jun. 1, 2015

(51) Int. Cl. H04N 21/2543; H04N 7/16; H04N 21/2668; H04N 21/27; H04L 29/06; H04N 21/258

(52) U.S. Cl. CPC H04N 21/2543; H04L 65/1063; H04N 21/25891; H04N 21/2668; H04N 21/27; H04N 7/165

(57) ABSTRACT

Systems and methods for incentivizing computerized personalization of content delivered via a digital medium are disclosed. An embodiment of the method includes receiving, via a content subscription server, at least one indicator of content item deselection from a predetermined content subscription package having a plurality of digital content items. The method further includes determining, via the content subscription server, a subscription state for a user based on removing digital content corresponding to the at least one indicator of content item deselection from the predetermined content subscription package, as well as determining, via the content subscription server, an incentive balance for the user based on the at least one indicator of content item deselection. The method additionally includes reducing, via the content subscription server, a content acquisition price for the user based on the incentive balance.

### TECHNICAL FIELD

The present disclosure relates generally to digital content distribution, and more specifically to computerized personalization of content delivered via a digital medium.

### BACKGROUND

Presently, users of paid television services do not have the optimal television viewing experience in large part due to a sheer number of channels that are preconfigured into fixed packages by television service providers or broadcasters. This minimizes usage and results in dissatisfaction because the users are forced to pay for and search for content among channels in which they have no interest. While a la carte channel options exist, broadcasters want the opportunity to sell content in a single package rather than have users purchase a la carte in order to increase revenue. A similar problem also arises in other industries in connection with online purchasing decisions. Therefore, a method is needed that would bridge the needs of the content providers, broadcasters and consumers in connection with online purchasing.

### SUMMARY

Embodiments of the present disclosure provide a system and method for digital content subscription personalization. As described in further detail below, embodiments of the present disclosure provide both new and existing customers incentives and ability to customize their TV channel selections within the context of a specific content package that is pre-defined.

In one embodiment, a method for computerized personalization of digital content purchasing is disclosed. The method includes receiving, by a content subscription server, at least one indicator of content item deselection from a predetermined content subscription package having a plurality of digital content items. The method further includes determining, by the content subscription server, a subscription state for a user based on removing digital content corresponding to the at least one indicator of content item deselection from the predetermined content subscription package, as well as determining, by the content subscription server, an incentive balance for the user based on the at least one indicator of content item deselection. The method additionally includes reducing, by the content subscription server, a content acquisition price for the user based on the incentive balance.

In another embodiment, a content subscription server is disclosed. The server includes a processor and memory. The memory includes computer readable instructions executed by the processor that cause the processor to (a) receive at least one indicator of content item deselection from a predetermined content subscription package having a plurality of digital content items, (b) determine a subscription state for a user based on removing digital content corresponding to the at least one indicator of content item deselection from the predetermined content subscription package, (c) determine an incentive balance for the user based on the at least one indicator of content item deselection, and (d) reduce a content acquisition price for the user based on the incentive balance.

In yet another embodiment, a method for personalization of packaged options is disclosed. The method includes receiving, via an option processing server, at least one indicator of option deselection from an option package having a plurality of predetermined option items, and determining, via the option processing server, an option selection state for a user based on the at least one indicator of option deselection from the option package. The method further includes determining, via the option processing server, an incentive balance for the user based on the at least one indicator of option deselection, and reducing, via the option processing server, an item acquisition price for the user based on the incentive balance.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 is a diagram illustrating a digital content distribution system in accordance with an embodiment of the present disclosure;

FIG. 2 is a flow chart illustrating an embodiment of a method for computerized personalization of digital content subscription via the system of FIG. 1;

FIG. 3 is a flow chart illustrating an embodiment of personalization aspects of a user interface of an application running on a digital content player device of FIG. 1; and

FIGS. 4-10 are diagrams illustrating an embodiment of a user interface of an application executed by the digital content player device of FIG. 1.

### DETAILED DESCRIPTION

The present disclosure is herein described in detail with reference to embodiments illustrated in the drawings, which form a part hereof. Other embodiments may be used and/or other changes may be made without departing from the spirit or scope of the present disclosure. The illustrative embodiments described in the detailed description are not meant to be limiting of the subject matter presented herein.

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the present disclosure.

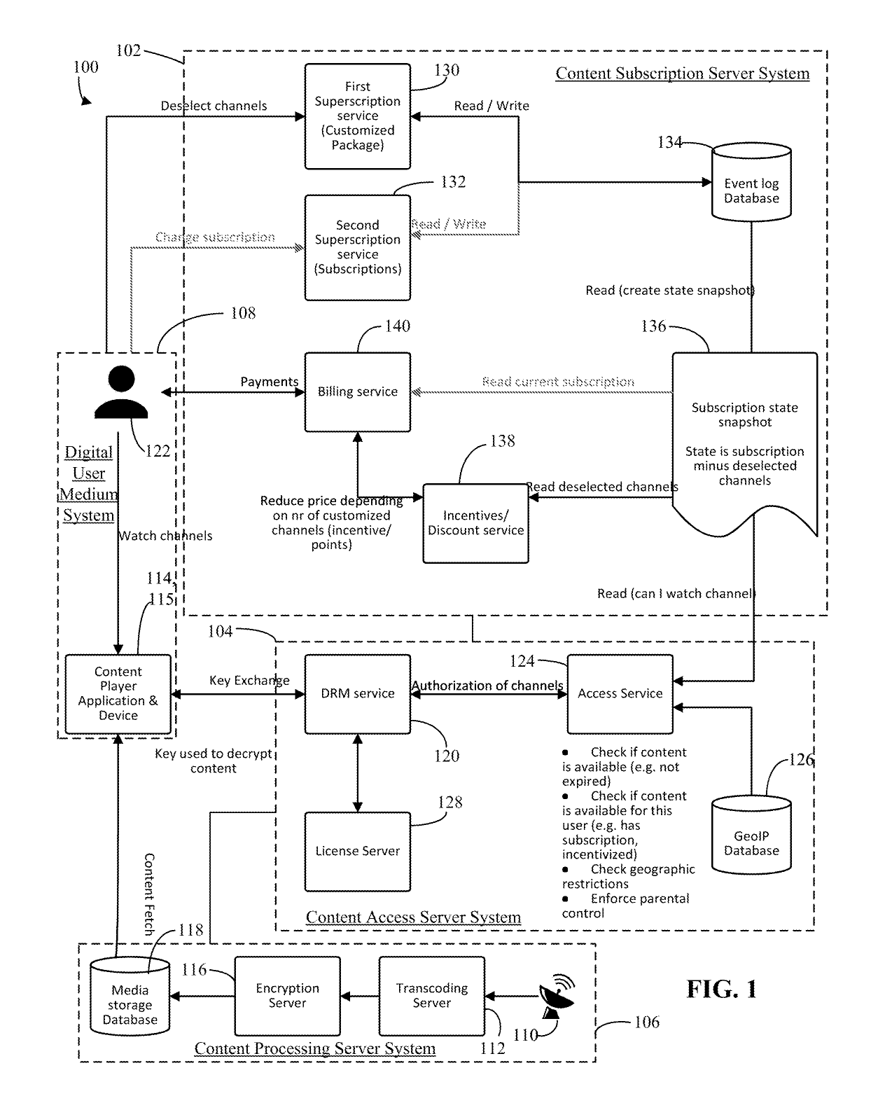

Referring to FIG. 1, a digital content distribution system 100 for providing content subscription personalization incentives is shown. The digital content distribution system 100 of the present disclosure administers user subscriptions and billing by providing content personalization incentives to customize channel selections within predefined subscription packages. In one embodiment, the personalization incentives include points and corresponding subscription discounts that are awarded for reducing the number of channels that comprise a given predefined subscription package. This ensures that the remaining channels are properly aligned with user interests and maximizes the viewing time for each of the remaining channels in the package.

The system 100 includes a plurality of content server systems 102-106, as well as a user digital medium system 108, which is connected to content server systems 102-106 via a network, such as the Internet, a wide are network (WAN), a local area network (LAN), and/or a mobile telephone network, or the like. In particular, the system 100 includes a content processing server system 106 that receives digital content, such as live television (TV) streams, from a content provider through a content delivery network (CDN) via communication equipment 110. Although the illustrated embodiment is described with respect to TV content streaming, those skilled in the art will realize that the present disclosure is not limited to particular content types and may be applicable to, for example, audio content delivery, photo content delivery, or any other content amenable to personalization in view of incentives applied in a digital medium, including additional examples, such as car option package personalization, described below. In various embodiments, the communication equipment 110 includes satellite and/or microwave receiver or transceiver and antenna equipment for receiving the live TV stream. Alternatively or in addition, the live TV content may be received via a wireline connection, such as a dedicated land-line or fiber. Additional embodiments of content delivery media include coax, TP-cable, xDSL, radio link or DTH, as well as hybrid solutions, such as IP over PDH or Ethernet-based FTTB. The content processing server system 106 is largely agnostic to the received content signal's encoding format, transport layer, and physical delivery media. In embodiments, the content signal, when it is received, may have been encoded in SDI, MPEG-2 4:2:2, MPEG-2 4:2:0, MPEG-4 4:4:4, MPEG-4 4:2:2, MPEG-4 4:2:0, JPEG-2000 or SMPTE VC-1 format. Embodiments of the transport layer include SDI/ASI, IP, DVB-S2, PDH, SDH or NGSDH (DTM), among others. In one embodiment, the content processing server system 106 receives a HD-SDI encoded content signal over IP on redundant fiber.

The received content signal is then transcoded by the transcoding server 112 into a digital format that is compatible with the system 100, including the format that is compatible with the access control, digital rights management (DRM), and subscription management server systems and their associated services and that may be replayed via the digital content player application 114 and associated digital content player device 115. In one embodiment, the content player application 114 running on the player device 115 issues content requests, performs streaming, and communicates user selections and commands to the content subscription server system 102, content access server system 104, and content processing server system 106 via HTTP. In various embodiments, the player device 115 may be a mobile phone, a tablet, a computer, a dedicated audio/video digital content streamer, including a smart TV device, or a device running an internet browser. The content player application 114 may be a stand-alone mobile or desktop application, as well as a browser based application, such as a plug-in.

The encryption server 116 encrypts the transcoded digital content for storage in the media storage database 118. In an embodiment, the encryption is applied subsequent to processing by the DRM service 120 executed by the content access server system 104, where the DRM service 120 wraps the segments in a DRM protective cover in accordance with the content license specifications stored in the license server 128.

The content access server system 104 is responsible for authenticating and authorizing access when a user 122 initiates a request to view particular content (e.g., a live or pre-recorded TV stream) via a content viewer application 114 executing on the playback device 115. In addition to the DRM service 120, the content access server system 104 executes an access service 124, which ensures that the requested content is generally available (e.g., that it has not expired) and that it is available for a particular user 122 based on the user's subscription, which may be modified in view of the incentives associated with package personalization channel selections and/or de-selections, as discussed in further detail below. The access service 124 also accesses an IP geolocation (GeoIP) database 126 in order to check geographic restrictions, such as restrictions affecting content availability for users associated with a specific geographic region (e.g., based on a location in the subscription profile or location determined based on an IP address associated with the content request). The access service 124 also accesses parental control settings associated with a user's profile, which in one embodiment is stored in a separate database, as part of issuing an authorization approval for the requested content. In an embodiment, a user's profile may include parental control settings on channel-wide, program-specific, ratings-specific, or topic-specific level. When the access service 124 issues an authorization to access the requested content, the DRM service 120 exchanges encryption keys with the content player application 114 running on the player device 115 for the user to decrypt the requested content. The requested content is then fetched, in an encrypted form, from the media storage database 118.

In accordance with the present disclosure, the content subscription server system 102 administers user subscriptions and billing by providing content personalization incentives to customize channel selections within predefined subscription packages. In the illustrated embodiment, the personalization incentives include points that are awarded for reducing the number of channels that comprise a given predefined subscription package. This ensures that the remaining channels are properly aligned with user interests and maximizes the likelihood that the user will increase viewing time for each of the remaining channels in the package. The increase in average viewing time per channel, in turn, increases the value of advertising content and makes it better targeted to the user's interests. In this embodiment, the user 122 accumulates points by de-selecting one or more channels from the package. The points balance is then converted to a monetary discount which is applied to the subscription bill. Alternatively, the user 122 may choose to accumulate some or all of the point incentives for later use or apply some or all of the point incentives toward adding one or more channel from another (e.g., higher priced) predefined subscription package. While the illustrated embodiment involves generation of incentive points for de-selecting channels within a pre-defined lineup or package, the present disclosure is not limited to this method of generating content personalization incentives. In various non-limiting examples, content personalization points (and corresponding discount balances) may be awarded for other content personalization activities. Such content personalization activities may include the user 122 selecting via the application 114 to receive notifications when a certain show is about to become available for viewing, sharing the user's watch list and/or electronic program guide (EPG) channel order with other users of the system 100 and/or via social media, entering social media account information into the application 114, creating family member accounts, signing up for paid subscription after a free trial period, watching or otherwise consuming a predetermined amount of TV or other digital content, as well as ad hoc points awarded by content providers for watching or otherwise consuming specific TV or other digital content, among others.

In the illustrated embodiment, the content subscription server system 102 executes a plurality of services for communicating subscription package selections and personalization settings, as well as payment information, to and from the user application 114. In particular, the first superscription service 130 receives, for example via HTTP messaging, channel deselection indicators entered into the application 114, as well as other content personalization activity settings described above. Similarly, the second superscription service 132 receives channel plan indicators corresponding to the deselected channel indicators received via the first superscription service 130. The channel deselection indicators and the corresponding channel plan indicators are stored in the event log database 134. The subscription state snapshot service 136 reads the event log database 134 to determine the user's subscription status by removing the deselected channel plan indicators from the list of channel indicators associated with the user's channel package(s) and updates the access service 124. To provide the content personalization incentives, the incentives service 138 reads a list of deselected channels from the subscription state snapshot service 136 and calculates a discount in the user's subscription price based on the number of accumulated personalization points. In an embodiment, the personalization points awarded for deselecting a given channel vary based on the package from which the channel was deselected (e.g., high-cost channel deselection results in a higher point balance award as compared to low-cost or free channel deselection). The billing service 140 reads the discount calculated by the incentive service 138, applies it to the user's current subscription read from the subscription state snapshot service 136. Additionally, the billing service 140 processes subscription payments submitted by the user 122 via the content player application 114 executing on the player device 115.

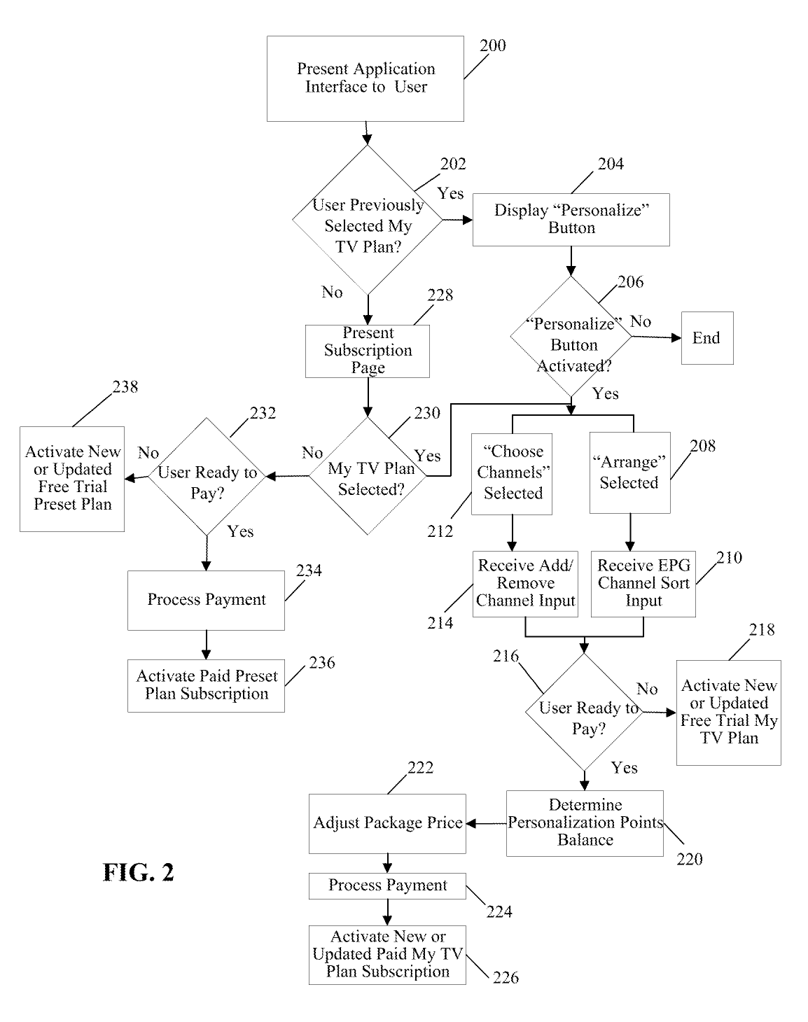

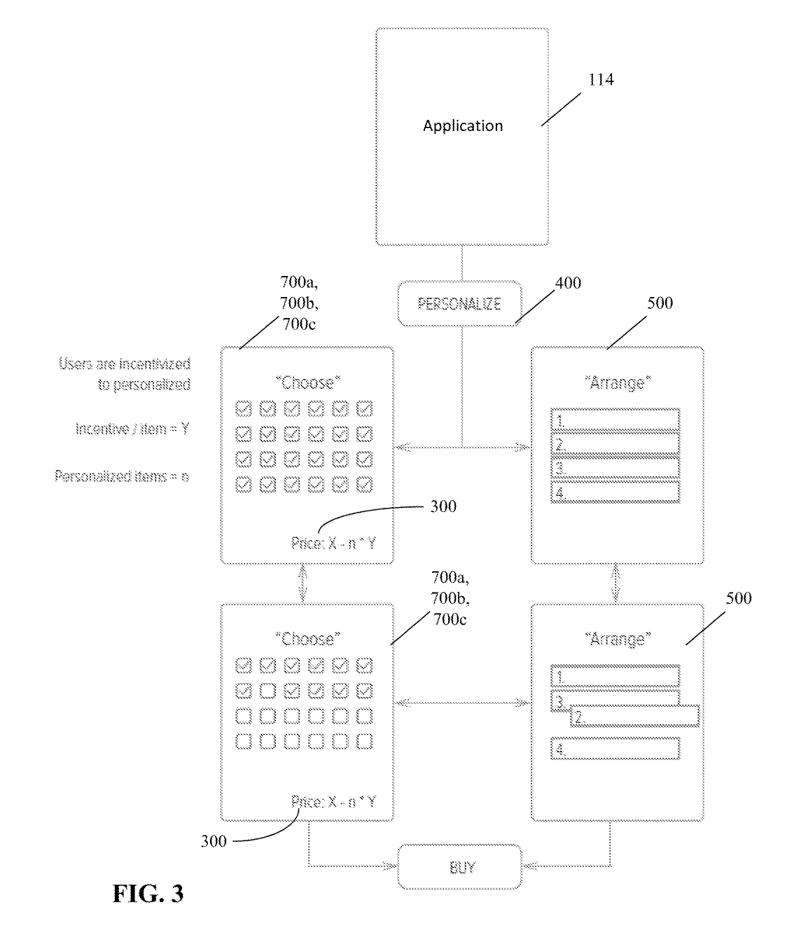

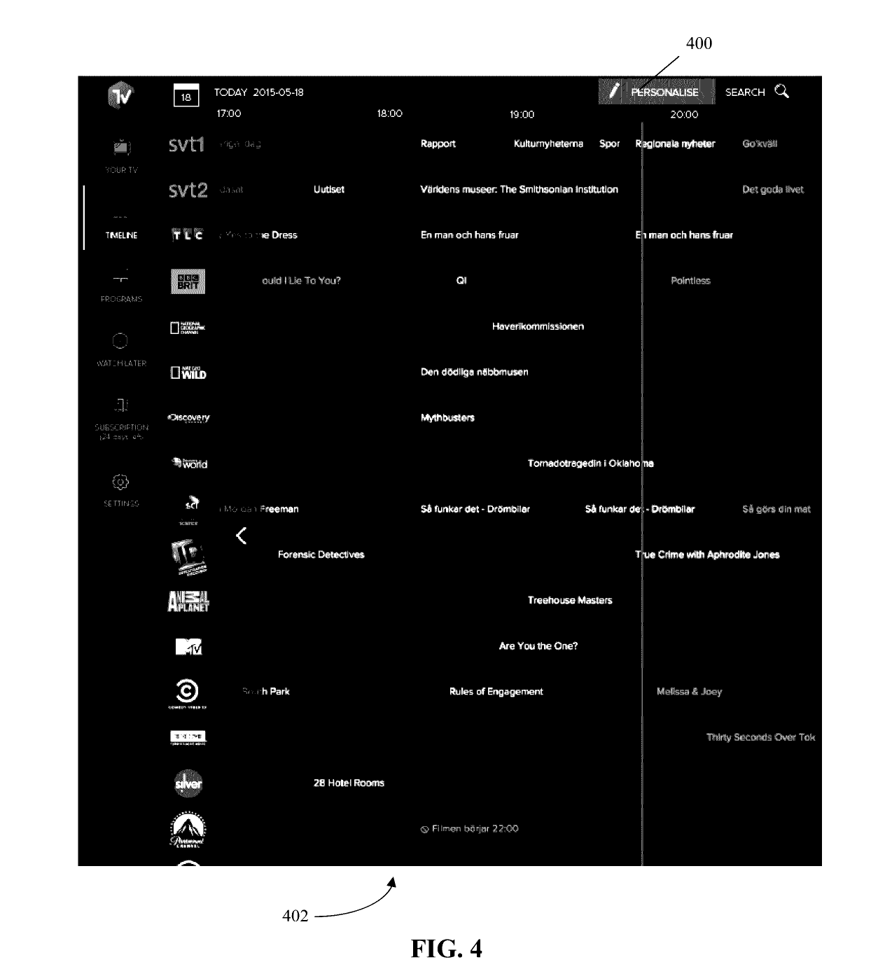

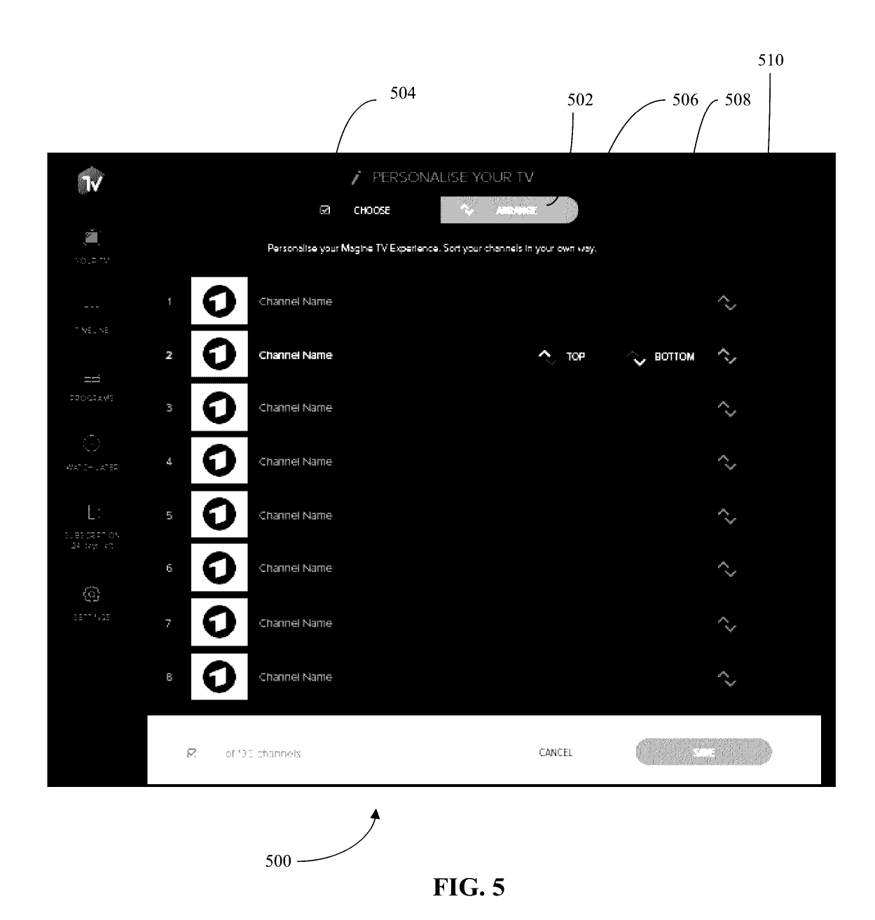

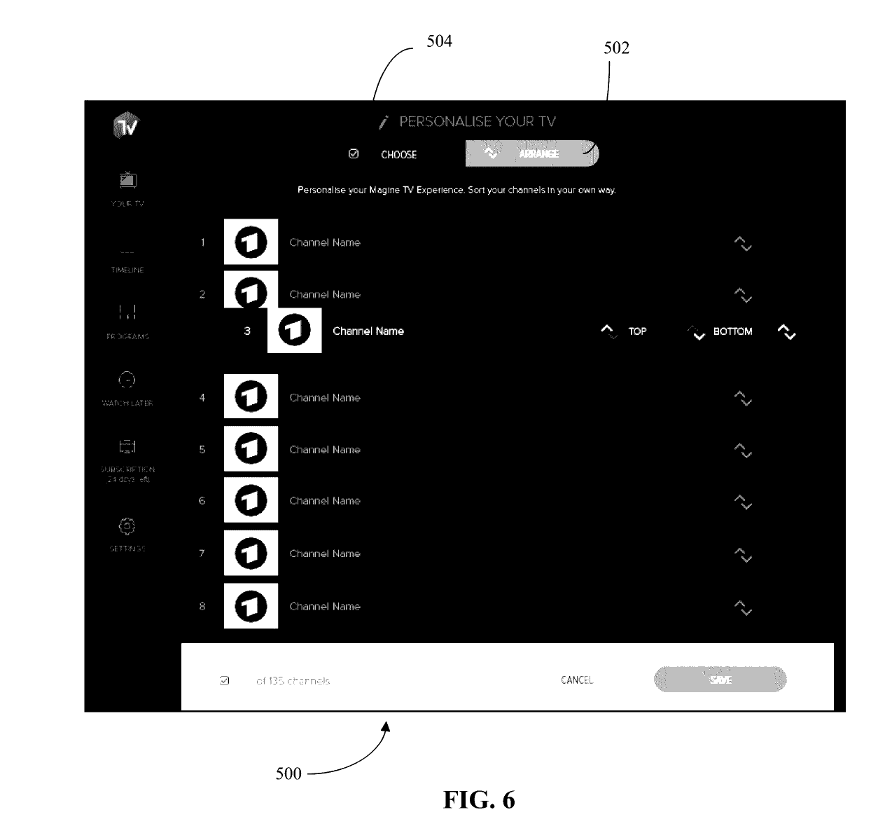

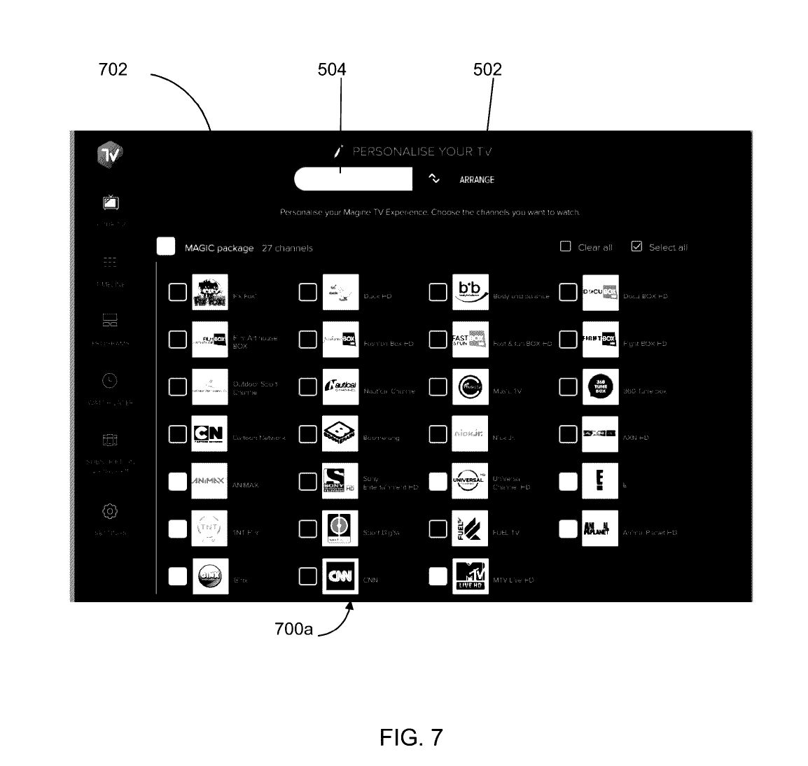

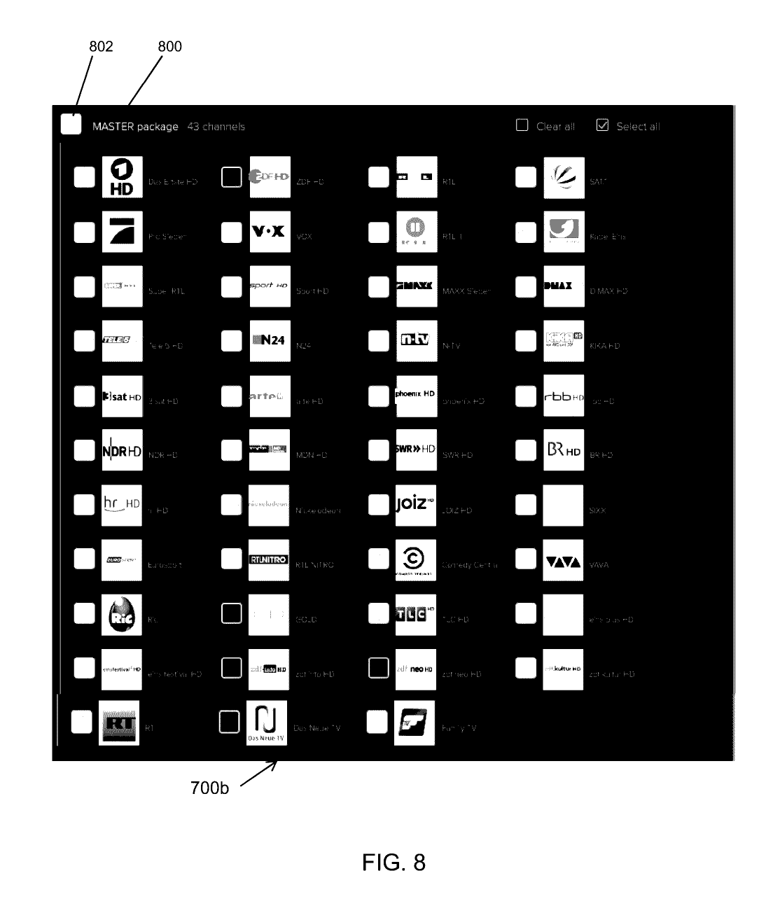

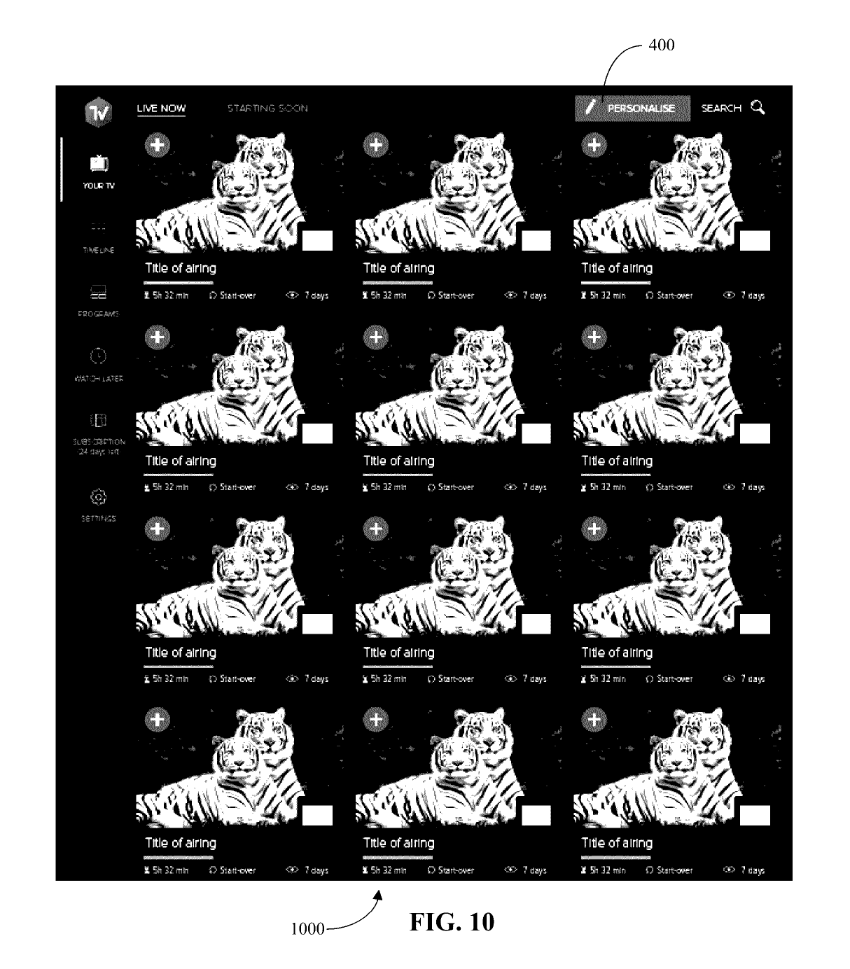

Referring to FIG. 2, an embodiment of a method for presenting the user with content personalization incentives via a user interface of the application 114, depicted in FIGS. 3-10, is shown. In step 200, the digital content distribution system 100 presents an application user interface for selecting a TV package subscription or initiating a free trial via a digital content player device 115. If, in step 202, the user had previously selected a “My TV Plan” by personalizing a set of channels from one or more preset subscription packages, then, in step 204, the “personalize” button 400 is displayed in the electronic program guide (EPG) pages 402, 1000 (FIGS. 4, 10). In an embodiment, the user selects what is referred to as the “My TV Plan” by deselecting one or more TV channels from a preset channel package line up presented via a subscription screen 700a, 700b, 700c that spans FIGS. 7-9. In step 206, if the user activates the “Personalize” button 400 (FIGS. 3-4), he is then presented with the content personalization screen 500 depicted in FIGS. 5-6. The content personalization screen 500 allows the user to personalize the content viewing experience by customizing the sort order of the TV channels in the EPG via the “Arrange” button 502. In step 208, when the user selects the “Arrange” button 502, the user is able to re-arrange the sort order of the channels appearing on the EPG, for example either by dragging a given channel icon to a desired position or by selecting the up and down sort buttons 506-510, as shown in FIG. 6. In step 210, the content subscription server system 102 receives user input of EPG channel sort order.

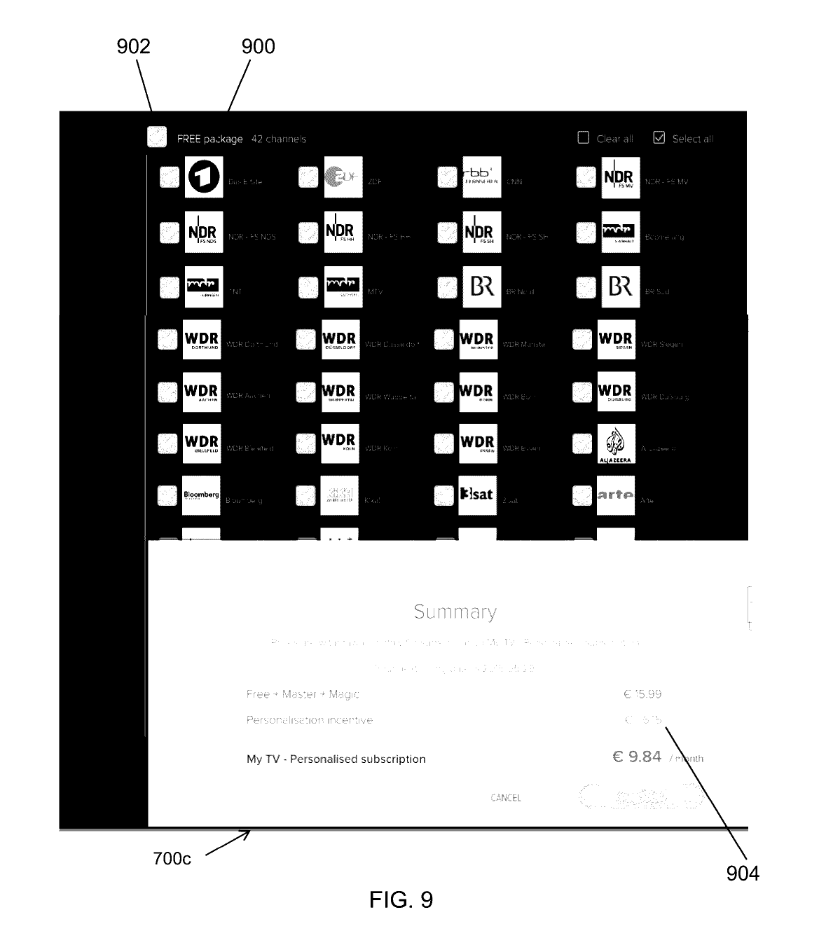

Additionally, the user is incentivized to further personalize his subscription by customizing the channel selections via the “Choose Channels” button 504. To this end, in steps 212-214, the content subscription server system 102 receives user input of channel de-selections when the user 122 deselects one or more channels from the preset channel packages presented via the subscription screen 700a, 700b, 700c that spans FIGS. 7-9. As shown in further detail in FIGS. 7-9, the subscription screen displays a plurality of preset channel packages, such as the “Magic” package 702, the “Master” package 800, and the “Free” package 900 (e.g., streamed public television TV channels). A selection box disposed next to each of the channel names and package names allows the user to select or deselect a given package or channel name. For example, as shown in the embodiment of FIG. 7, the user deselected a majority of the channels within the preset “Magic” package by deselecting the corresponding channel selection boxes, while selecting all of the channels in the “Master” package 800 and “Free” package 900 via package selection boxes 802, 902. In an embodiment, deselection of a channel within a given TV package results in an award of a point balance to the user. In the illustrated embodiment, the point balance award may be higher for paid channels, such as the “Magic” package 702, with respect to the free or lower subscription based channels, such as the “Master package 800 and “Free” package 900. The content subscription server system 102 converts the user's personalization point award balance to a subscription discount when the user selects a paid subscription. In one embodiment, shown in FIG. 3, the user's personalization points balance and/or associated discounted price 300 is displayed and updated in real time as the user deselects channels from a given TV package. In another embodiment, the personalization point balance and/or associated subscription discount is displayed when the user is ready to purchase the personalized subscription, as shown in FIG. 9 (e.g., “personalization incentive” 904).

Referring again to FIG. 2, in steps 216-218, if the user is not yet ready to pay, the personalized “My TV” plan selected by the user is activated or updated as part of a free trial (if available in accordance with permissions set by the access service 124). Otherwise, if the user is ready to pay for the personalized subscription, in steps 220-222, the content subscription server system 102 determines the user's personalization points balance in accordance with channel deselections made by the user and adjusts the package price in accordance with the corresponding personalization incentive discount. In another embodiment, user's customized EPG channel sorting selections, as well as any of the additional personalization options discussed above in connection with FIG. 1, also result in personalization points and corresponding subscription discounts determined by the content subscription server system 102. In steps 224-226, the content subscription server system 102 processes user payment and activates a new or updated personalized “My TV Plan” paid subscription.

Referring again to step 202 of FIG. 2, in the event that the user has not previously personalized his subscription by selecting the “My TV” plan, the user is presented with an opportunity to do so, in step 228, via the subscription screen 700a, 700b, 700c (FIGS. 7-9). If, in step 230, the user elects to personalize his channel subscription, the flow continues to steps 208-226 as described above. Otherwise, when the user is ready to pay, he elects one or more preset TV channel packages 702, 800, 900 without making the deselections of any channels—and hence personalization incentives are not applied when the content subscription server system 102 processes payment and activates the preset plan paid subscription, steps 232-236. In the event the user is not yet ready to pay, the content subscription server system 102 activates or updates the free trial subscription to the preset plan(s) selected by the user, step 238. As those of skill in the art will realize, some or all of the functionality executed by content subscription server system 102 may be shared with or instead performed by the user's content player device 114 (e.g., when programmed into application code or loaded into device memory).

While the foregoing description discussed digital TV streaming channel subscription personalization embodiments, those of skill in the art will realize that the systems and methods described herein are also applicable in a plurality of other contexts. Among various additional examples, for instance, is using preset package personalization incentives in the context of automobile orders communicated via a digital medium (e.g., online) where a consumer receives reward points for deselecting one or more features of a predetermined options package. This optimizes manufacturing efficiency by decreasing the time and expense needed to manufacture unpopular options. Additional examples of various contexts in which the present disclosure is applicable include music and movies industries where pre-packaged content is offered to the user.

While various aspects and embodiments have been disclosed, other aspects and embodiments are contemplated. The various aspects and embodiments disclosed are for purposes of illustration and are not intended to be limiting, with the true scope and spirit being indicated by the following claims.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make and use the present invention. Various modifications to these embodiments will be readily apparent to those skilled in the art, and the generic principles defined here may be applied to other embodiments without departing from the spirit or scope of the invention. Thus, the present invention is not intended to be limited to the embodiments shown here but is to be accorded the widest scope consistent with the following claims and the principles and novel features disclosed here.

1. A method for computerized personalization of digital content purchasing, the method comprising:
serving, via a content subscription server, over a network, a page of a graphical user interface to a client comprising a display such that the display presents the page, the page comprising a predetermined content subscription package area and a plurality of content item element pairs positioned within the predetermined content subscription package area, each of the content item element pairs being defined by an input element and a content item identifier element associated with the input element, the input element being configured to receive an input indicative of either a content item selection or a content item deselection;
receiving, via the content subscription server, over the network, from the client, based on at least one of the inputs, at least one indicator of the content item deselection, and determining, via the content subscription server, a subscription state data for a user profile based on reading, via the content subscription server, an event log and removing, via the content subscription server, based on the reading, a digital content identifier from a first data structure associated with the user profile, the digital content identifier corresponding to the at least one indicator of the content item deselection;
determining, via the content subscription server, an incentive balance value of the user profile based on the at least one indicator of the content item deselection and the subscription state data, and accessing, via the content subscription server, a content acquisition price value stored in a second data structure associated with the user profile and reducing, via the content subscription server, the content acquisition price value in the second data structure based on the incentive balance value, n the content acquisition price value before the reducing being associated with at least one of the input elements as selected before the reducing; and
in response to the reducing, serving, via the content subscription server, over network, the content acquisition price value as reduced to the client such that the display presents the page containing the content acquisition price value as reduced.

2. The method of claim 1, wherein at least one of the content item element pairs is associated with a digital television channel content.

3. The method of claim 1, wherein the client comprises a digital player device.

4. The method of claim 3, wherein the digital player device is selected from a group consisting of a mobile phone, a tablet, a smart TV device, and a device running a network browser.

5. The method of claim 3, wherein the graphical user interface is presented via an application running on an operating system of the client.

6. The method of claim 1, wherein the subscription state data includes a plurality of predetermined subscription package identifiers and the incentive balance value is varied in accordance with the at least one indicator of content item deselection associated with corresponding one of the predetermined subscription package identifiers.

7. (canceled)

8. The method of claim 2, further comprising receiving, by the content subscription server, over the network, from the client, a user input of a channel sort order in an electronic program guide served to the client over the network, wherein the user input is via the page presenting the electronic program guide.

9-16. (canceled)

17. A method for personalization of packaged options, the method comprising:
serving, via an option processing server, over a network, a page of a graphical user interface to a client comprising a display such that the display presents the page, the page comprising a predetermined option package area and a plurality of option item element pairs positioned within the predetermined option package area, each of the option item element pairs being defined by an input element and an option item identifier element associated with the input element, the input element being configured to receive an input indicative of either an option item selection or an option item deselection;
in response to receiving, via the option processing server, over the network, from the client, based on at least one of the inputs, at least one indicator of the option deselection, determining, via the option processing server, an option selection state data for a user profile based on reading, via the option selection server, an event log and removing, via the option selection server, based on the reading, an option item identifier from a first data structure associated with the user profile, the option item identifier corresponding to the at least one indicator of the option item deselection;
determining, via the option processing server, an incentive balance value of the user profile based on the at least one indicator of the option item deselection and the option selection state data, accessing, via the option processing server, an item acquisition price value stored in a second data structure associated with the user profile, and reducing, via the option processing server, the item acquisition price value in the second data structure based on the incentive balance value, the item acquisition price value before the reducing being associated with at least one of the input elements as selected before the reducing;
in response to the reducing, serving, via the option processing server, over the network, the item acquisition price value as reduced to the client such that the display presents the page containing the item acquisition price value as reduced.

18. The method of claim 17, wherein the predetermined option package area is associated with a TV channel package identifier.

19. The method of claim 17, wherein the predetermined option package area is associated with an automobile option package identifier.

20. The method of claim 17 wherein the option processing server is a content subscription server.

21. A system comprising a server comprising a processor and a memory, the processor being coupled to the memory, the memory storing a set of instructions instructive of the processor to perform a method of computerized personalization of digital content purchasing, wherein, the method comprises:
serving, via the server, over a network, a page of a graphical user interface to a client comprising a display such that the display presents the page, the page comprising a predetermined content subscription package area and a plurality of content item element pairs positioned within the predetermined content subscription package area, each of the content item element pairs being defined by an input element and a content item identifier element associated with the input element, the input element being configured to receive an input indicative of either a content item selection or a content item deselection;
in response to receiving, via the content subscription server, over the network, from the client, based on at least one of the inputs, at least one indicator of the content item deselection, determining, via the server, a subscription state data for a user profile based on reading, via the server, an event log and removing, via the content subscription server, based on the reading, a digital content identifier from a first data structure associated with the user profile, wherein the digital content identifier corresponds to the at least one indicator of the content item deselection;
in response to determining, via the server, an incentive balance value of the user profile based on the at least one indicator of the content item deselection and the subscription state data, accessing, via the server, a content acquisition price value stored in a second data structure associated with the user profile and reducing, via the server, the content acquisition price value in the second data structure based on the incentive balance value, the content acquisition price value before the reducing being associated with at least one of the input elements as selected before the reducing;
in response to the reducing, serving, via the server, over the network, the content acquisition price value as reduced to the client such that the display presents the page containing the content acquisition price value as reduced.

22. The system of claim 21, wherein at least one of the content item element pairs is associated with a digital television channel content.

23. The system of claim 21, wherein the client comprises a digital player device.

24. The system of claim 23, wherein the digital player device is selected from a group consisting of a mobile phone, a tablet, a smart TV device, and a device running a network browser.

25. The system of claim 23, wherein the graphical user interface is presented via an application running on an operating system of the client.

26. The system of claim 21, wherein the subscription state data includes a plurality of predetermined subscription package identifiers and the incentive balance value is varied in accordance with the at least one indicator of content item deselection associated with corresponding one of the predetermined subscription package identifiers.

27. The system of claim 22, wherein the method further comprises receiving, by the content subscription server, over the network, from the client, a user input of a channel sort order in an electronic program guide served to the client over the network, wherein the user input is via the page presenting the electronic program guide.

28. The method of claim 1, wherein the input element is a binary choice input element.
